(19) United States
(12) Patent Application Publication
(10) Pub. No.: US 2012/0151409 A1
(43) Pub. Date: Jun. 14, 2012

(54) Electronic Apparatus and Display Control Method

(76) Inventors: Kyohei Matsuda, Ome-shi (JP); Yukihiro Suda, Tachikawa-shi (JP)

(21) Appl. No.: 13/207,129

(22) Filed: Aug. 10, 2011

(30) Foreign Application Priority Data
Dec. 14, 2010 (JP) 2010-278068

(51) Int. Cl. G06F 3/048

(52) U.S. Cl. 715/800; 715/781

(57) ABSTRACT

According to one embodiment, an electronic apparatus displays one or more windows of a plurality of windows corresponding to a plurality of application programs on a touch-screen display, and includes a storage device, a display control module and an execution control module. The storage device stores operation screen information items associated with the application programs. The display control module displays a operation screen based on a first item of the items when a predetermined area in a first window of the plurality of windows has been touched, the operation screen including buttons for operating a first application program of the application programs, the first item being associated with the first application program, the first application program corresponding to the first window. The execution control module instructs the first application program to execute a function corresponding to a button of the buttons in response to the button being touched.

### CROSS-REFERENCE TO RELATED APPLICATIONS

This application is based upon and claims the benefit of priority from prior Japanese Patent Application No. 2010-278068, filed Dec. 14, 2010, the entire contents of which are incorporated herein by reference.

### FIELD

Embodiments described herein relate generally to an electronic apparatus including a touch-screen display and a display control method which is applied to the apparatus.

### BACKGROUND

In recent years, various electronic apparatuses having touch-screen displays, such as a personal computer, a PDA and a smartphone, have been gaining in popularity. A user can intuitively manipulate a graphical user interface (GUI) displayed on the screen, by using the touch-screen display. For example, the window of an application program includes an area for displaying a document, an image, etc., and an area (e.g. a toolbar) for displaying a GUI such as a button and a menu. The user can intuitively indicate the GUI by using the touch-screen display.

The user manipulates the touch-screen display, for example, by a finger. Thus, for example, when an object that is a target of operation, which is displayed on the screen of the touch-screen display, is small, it is difficult to exactly indicate the object, and it is possible that time is consumed for the operation or that a process which is not intended by the user is executed by an erroneous operation.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is an exemplary block diagram showing the system configuration of the electronic apparatus of the embodiment.

FIG. 3 is an exemplary block diagram showing the functional structure of an operation screen control program which is executed by the electronic apparatus of the embodiment.

FIG. 4 shows an example of operation screen information which is used by an operation screen control program which is executed by the electronic apparatus of the embodiment.

FIG. 5 shows an example of the operation screen which is displayed by the electronic apparatus of the embodiment.

FIG. 6 shows another example of the operation screen which is displayed by the electronic apparatus of the embodiment.

FIG. 7 shows still another example of the operation screen which is displayed by the electronic apparatus of the embodiment.

FIG. 8 is an exemplary flowchart illustrating an example of the procedure of a display control process which is executed by the electronic apparatus of the embodiment.

### DETAILED DESCRIPTION

Various embodiments will be described hereinafter with reference to the accompanying drawings.

In general, according to one embodiment, an electronic apparatus displays one or more windows of a plurality of windows on a touch-screen display, the plurality of windows corresponding to a plurality of application programs. The electronic apparatus includes a storage device, a display control module and an execution control module. The storage device stores a plurality of operation screen information items associated with the plurality of application programs. The display control module displays a operation screen on the touch-screen display based on a first operation screen information item of the plurality of operation screen information items when a predetermined area in a first window of the plurality of windows has been touched, the operation screen comprising a plurality of buttons for operating a first application program of the plurality of application programs, the first operation screen information item being associated with the first application program, the first application program corresponding to the first window. The execution control module instructs the first application program to execute a function corresponding to a button of the plurality of buttons on the operation screen in response to the button being touched.

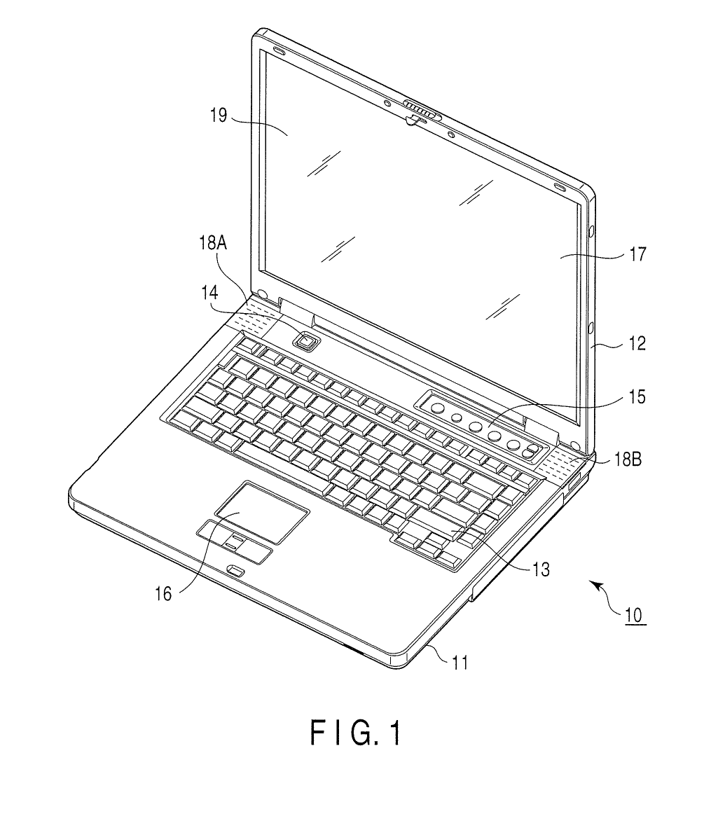

FIG. 1 is a perspective view showing the external appearance of an electronic apparatus according to an embodiment. The electronic apparatus is realized, for example, as a notebook-type personal computer 10. In addition, the electronic apparatus may be realized as a smartphone, a PDA, a tablet PC, etc. As shown in FIG. 1, the computer 10 includes a computer main body 11 and a touch-screen display 17.

A liquid crystal display (LCD) 17A and a touch panel 17B are built in the touch-screen display 17. The touch panel 17B is disposed in a manner to cover the screen of the LCD 17A. The touch-screen display 17 is attached to the computer main body 11 such that the touch-screen display 17 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a touch pad 16, and speakers 18A and 18B are disposed on the top surface of the housing of the computer main body 11. Various operation buttons are provided on the input operation panel 15.

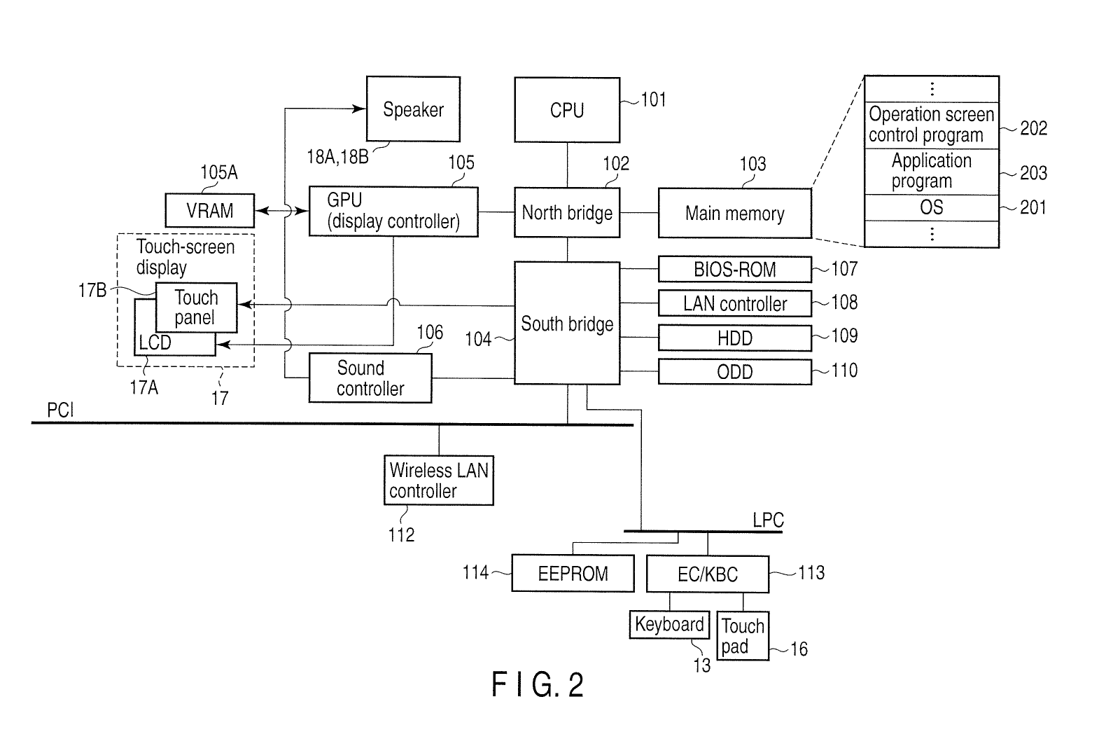

FIG. 2 shows the system configuration of the computer 10.

The computer 10, as shown in FIG. 2, includes a CPU 101, a north bridge 102, a main memory 103, a south bridge 104, a GPU 105, a VRAM 105A, a sound controller 106, a BIOS-ROM 107, a LAN controller 108, a hard disk drive (HDD) 109, an optical disc drive (ODD) 110, a wireless LAN controller 112, an embedded controller/keyboard controller (EC/KBC) 113, and an EEPROM 114.

The CPU 101 is a processor for controlling the operation of the computer 10. The CPU 101 executes an operating system (OS) 201, an operation screen control program 202 and various application programs, which are loaded from the HDD 109 into the main memory 103. The operation screen control program 202 has a function of controlling operation screens which are respectively associated with a plurality of application programs. The operation screen control program 202 displays an operation screen corresponding to an application program which is a target of operation, for example, in accordance with an operation by a user. By the user touching (or “tapping”) one of buttons included in the displayed operation screen, the operation screen control program 202 instructs the application program 203 to execute a function corresponding to the touched button.

In addition, the CPU 101 executes a BIOS stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of communicating with the GPU 105 via, e.g. a PCI EXPRESS serial bus.

The GPU 105 is a display controller which controls the LCD 17A that is used as a display monitor of the computer 10. A display signal, which is generated by the GPU 105, is sent to the LCD 17A. The LCD 17A displays video, based on the display signal.

The south bridge 104 controls devices on a peripheral component interconnect (PCI) bus and devices on a low pin count (LPC) bus. The south bridge 104 includes an integrated drive electronics (IDE) controller for controlling the HDD 109 and ODD 110.

The south bridge 104 includes a USB controller for controlling the touch panel 17B. The touch panel 17B is a pointing device for executing an input on the screen of the LCD 17A. The user can manipulate a GUI, etc. displayed on the screen of the LCD 17A. For example, by touching a button displayed on the screen, the user can instruct the execution of a function corresponding to this button.

The south bridge 104 also has a function of communicating with the sound controller 106. The sound controller 106 is a sound source device and outputs audio data to be played to the speakers 18A and 18B. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard.

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

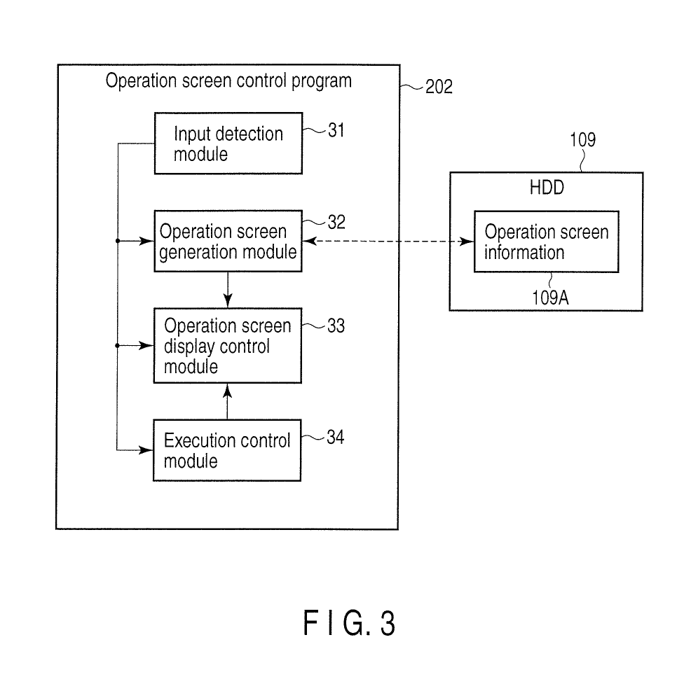

Next, referring to FIG. 3, a functional structure of the operation screen control program 202 is described. In the computer 10, a plurality of windows corresponding to a plurality of application programs 203 are displayed on the touch-screen display 17. For example, when the application program 203 is started, the OS 201 displays a window corresponding to this application program 203 on the touch-screen display 17. When one or more windows of the plurality of windows corresponding to the plurality of applications programs 203 are displayed on the touch-screen display 17, the operation screen control program 202 controls the operation screen for operating the application program 203.

The operation screen control program 202 includes an input detection module 31, an operation screen generation module 32, an operation screen display control module 33 and an execution control module 34.

The input detection module 31 detects an input by the use of the touch-screen display 17. The input detection module 31 detects that the user has operated (e.g. touched) an object, such as a button, a title bar, a side bar or an input area, which is included in the GUI displayed on the touch-screen display 17. For example, the input detection module 31 detects an operation on the object (GUI) by monitoring a message which is issued by the OS 301 in response to the input by the use of the touch-screen display 17. The input detection module 31 notifies the respective components of the operation screen control program 202 that the operation on the object has been detected.

When an input requesting the display of the operation screen for operating the application program 203 has been detected, the input detection module 31 notifies the operation screen generation module 32 that the input has been detected. Specifically, the input detection module 31 detects, for example, that a predetermined area (e.g. title bar) in the window has been touched. Then, the input detection module 31 notifies the operation screen generation module 32 that the predetermined area in the window has been touched.

Responding to the notification by the input detection module 31, the operation screen generation module 32 generates an operation screen including buttons for operating the application program 203.

Specifically, to begin with, the operation screen generation module 32 detects a process name corresponding to a window (also referred to as “first window”) on which the input (touch operation on the title bar) has been detected by the input detection module 31. Then, the operation screen generation module 32 detects the application program 203 corresponding to the detected process name. For example, the operation screen generation module 32 specifies the application program 203 in operation by comparing a process name, which is pre-registered in the registry, and the detected process name. Then, the operation screen generation module 32 reads an entry of operation screen information 109A which is associated with the specified application program 203.

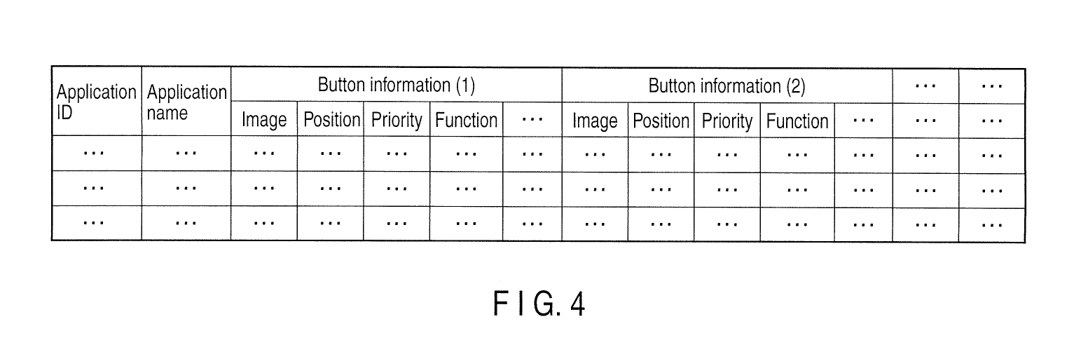

FIG. 4 shows a structure example of the operation screen information 109A. The operation screen information 109A is stored, for example, in the HDD 109. The operation screen information 109A includes a plurality of entries corresponding to a plurality of application programs. Each entry includes information for displaying the operation screen which is associated with the corresponding application program. Each entry includes, for example, an application ID, an application name, and button information. In an entry corresponding to a certain application program 203, “Application ID” indicates identification information which is given to this application program 203. “Application name” indicates the name of the application program 203.

“Button information” includes, for example, an image, a position, a priority, and a function. The operation screen includes at least one button. Thus, when a plurality of buttons are included in the operation screen, the entry includes a plurality of button information items corresponding to the plurality of buttons. In the “Button information” corresponding to a certain button, “Image” indicates a file name (file path) of an image which is used for the button. “Position” indicates the position of the button within the operation screen. “Priority” indicates the order of priority of display of this button in the operation screen among the plurality of buttons. For example, when a limited number of buttons are selected from the plurality of buttons, the operation screen generation module 32 preferentially selects buttons with lower values in the order of priority (i.e. buttons with higher priorities). “Function” indicates the function which is associated with the button. Thus, responding to the button being touched, the application program 203 is instructed to execute the function corresponding to the touched button.

The operation screen information 109A may further include a transparency of the operation screen, and a threshold period until the display of the operation screen is terminated. “Transparency” indicates the degree of transparency, with which the operation screen that is associated with the application program is transparently displayed on the window. “Threshold period” indicates a period until the display of the operation screen is terminated when none of the buttons is touched in the operation screen that is displayed on the window. Specifically, when an elapsed period, during which none of the buttons in the operation screen is touched, has reached the threshold period that is associated with the application program 203, the display of the operation screen is terminated. Besides, the “Button information” included in the operation screen information 109A may include information indicative of a size with which the button is to be displayed.

Referring to the operation screen information 109A, the operation screen generation module 32 determines whether the entry, which is associated with the specified application program (application program corresponding to the first window which is a target of operation) 203, is included in the operation screen information 109A. For example, when the entry including “Application name” corresponding to the detected application program 203 is included in the operation screen information 109A, the operation screen generation module 32 reads this entry as operation screen information (also referred to as “first operation screen information”) which is associated with the application program 203 (also referred to as “first application program”).

Next, the operation screen generation module 32 detects area information corresponding to the first window. The area information includes, for example, information indicative of the size of the window, the position of the window, etc. Using the read first operation screen information and the detected area information, the operation screen generation module 32 generates an operation screen including buttons for operating the first application program 203. The size of each of the buttons included in the operation screen is larger than, for example, the size of each of the buttons for operating the first application program 203 included in the first window. Besides, the size of a first button of the buttons included in the operation screen may be larger than the size of a second button for operating the first application program 203, which is included in the first window. In the meantime, when the first button has been pressed, the first application program 203 is instructed to execute the function associated with the second button. In other words, in the operation screen, the button included in the first window is displayed with an enlarged size.

Specifically, the operation screen generation module 32 first determines the area (operation screen display area) on which the operation screen is to be displayed based on the area information. The operation screen display area is, for example, an area of the first window, from which the title bar is excluded.

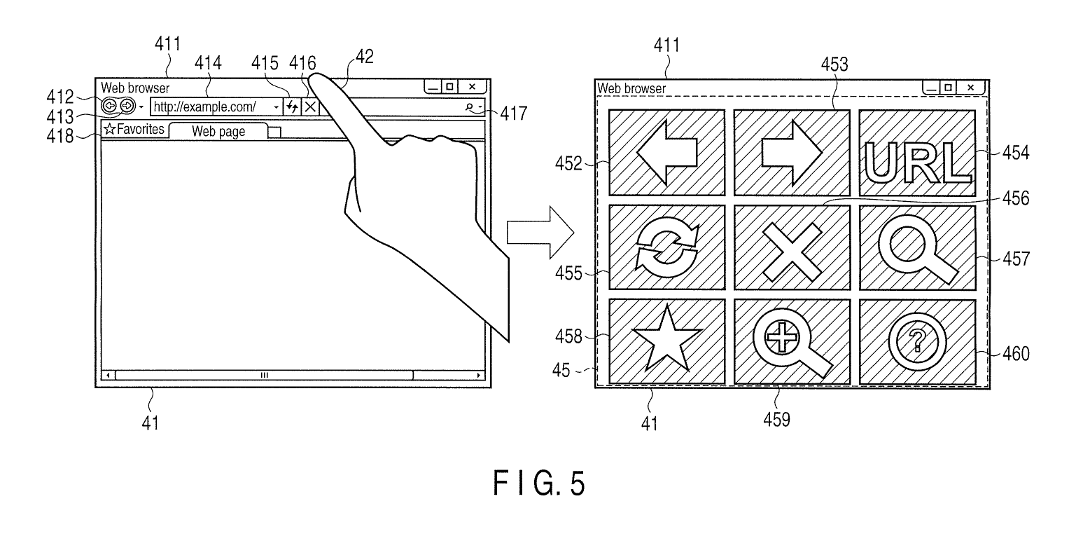

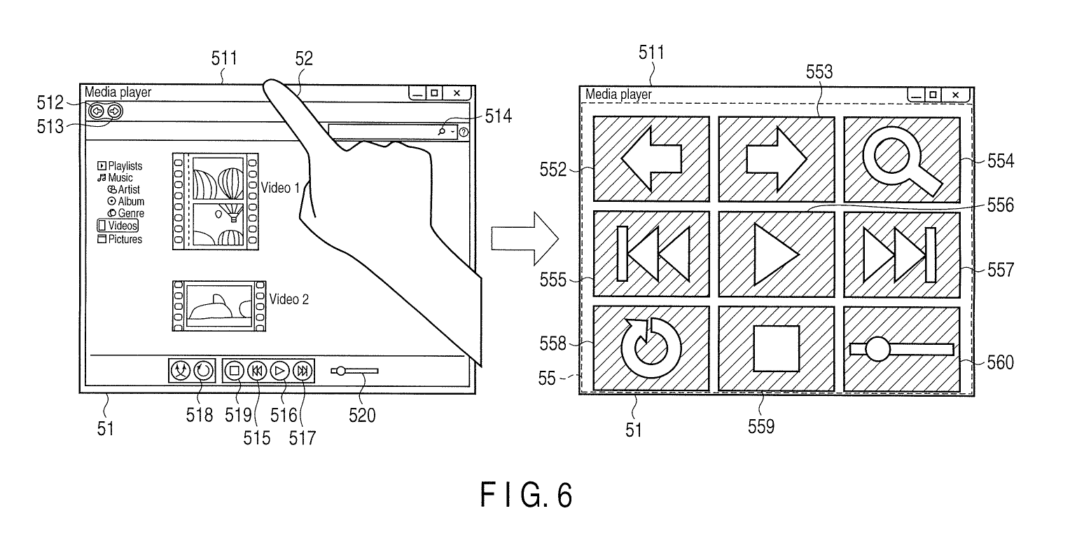

Subsequently, based on the “Button information” included in the first operation screen information, the operation screen generation module 32 determines the position, size, etc. of each of the buttons which are arranged in the operation screen. The operation screen generation module 32 determines the size of the button, for example, by dividing the operation screen display area, based on the number of buttons (e.g. nine) or the arrangement of buttons (e.g. 3×3 arrangement). Then, the operation screen generation module 32 generates an operation screen by arranging images of the buttons with the determined sizes at positions indicated by “Position” of “Button information”. Examples of the operation screen will be described later with reference to FIG. 5 and FIG. 6. The operation screen generation module 32 outputs the generated operation screen to the operation screen display control module 33.

In the meantime, the operation screen generation module 32 may generate an operation screen having a designated transparency, based on the “Transparency” included in the first operation screen information. With the transparent operation screen being displayed on the first window in an overlapping manner, the user can visually recognize which of the windows is being operated (i.e. which of the application programs is being operated). In addition, the user can easily understand that the function of the first application program 203, which corresponds to a button in the operation screen, is executed in response to the pressing of this button, that is, that the operation screen and the first window are synchronously worked.

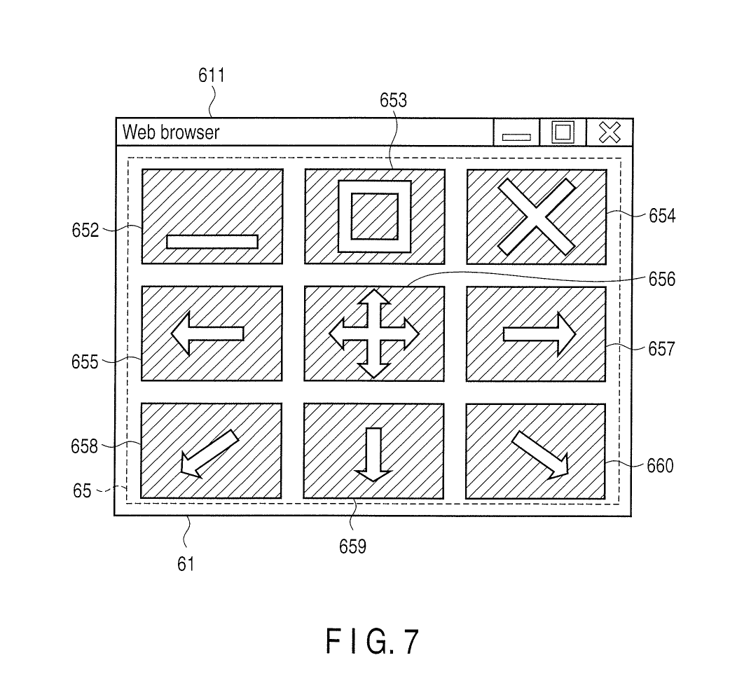

Further, the operation screen generation module 32 may generate a predetermined operation screen when the application program 203 corresponding to the first window on which the input has been detected (i.e. the application program 203 which is being operated) cannot be specified, or when there is no entry of the operation screen information 109A associated with the application program 203 which is being operated. This predetermined operation screen includes, for example, buttons for instructing execution of functions of, e.g. minimize, maximize, move, and resize of the window, which are common to various application programs. An example of this predetermined operation screen will be described later with reference to FIG. 7.

The operation screen display control module 33 displays the operation screen generated by the operation screen generation screen 32 on the first window in an overlapping manner.

Subsequently, when the operation screen is being displayed, the input detection module 31 detects that one of the buttons in the operation screen has been touched. Then, the input detection module 31 notifies the execution control module 34 that this one button has been touched.

In response to the notification by the input detection module 31, the execution control module 34 instructs the application program 203, which is the target of operation, to execute the function corresponding to the touched button. Specifically, the execution control module 34 determines the function corresponding to the touched button, based on the first operation screen information. The execution control module 34 then outputs, for example, a message or a command for executing this function. The application program 203 executes the function in accordance with the message or command which has been output from the execution control module 34.

Further, the execution control module 34 notifies the operation screen display control module 33 that the execution of the function corresponding to the touched button has been instructed. In response to the notification by the execution control module 34, the operation screen display control module 33 terminates the display of the operation screen.

Besides, the operation screen display control module 33 terminates the display of the operation screen, when an elapsed time period after the display of the operation screen, during which none of the buttons in the operation screen is touched, has reached a threshold period (e.g. ten seconds, or twenty seconds). The operation screen display control module 33 may terminate the display of the operation screen, when a time period, during which none of the buttons in the operation screen is touched, has reached a threshold period associated with the first application program 203.

When the operation screen is displayed, the input detection module 31 detects an input requesting the termination of the display of the operation screen. For example, the input detection module 31 detects the touch on a predetermined area (e.g. title bar) in the first window, as the input requesting the termination of the display of the operation screen. The input detection module 31 notifies the operation screen display control module 33 that the input requesting the termination of the display of the operation screen has been detected. In response to the notification by the input detection module 31, the operation screen display control module 33 terminates the display of the operation screen.

By the above-described structure, the operation screen control program 202 can easily execute an input by using the touch-screen display 17. When a predetermined area in the window has been touched, the operation screen generation module 32 displays the operation screen including buttons for operating the application program 203, based on the operation screen information 109A associated with the application program 203 corresponding to this window. Each of the buttons included in the displayed operation screen is displayed with a size which is larger than an object (GUI), such as a button, included in the window. By touching the button included in the operation screen, the user can instruct the application program 203 to execute the function corresponding to the touched button, more easily than touching, e.g. the button included in the window.

In the meantime, the operation screen generation module 32 may generate an operation screen including buttons with a size which is designated in the operation screen information 109A (button information). In this case, the operation screen display control module 33 changes the size of the first window in accordance with the size of the generated operation screen. For example, when the operation screen display area in the first window is smaller than the size of the generated operation window, the operation screen display control module 33 enlarges the size of the first window so that the operation screen display area may become equal in size to the operation screen. Then, the operation screen display control module 33 displays the operation screen on the first window which has been changed in size.

In addition, the operation screen generation module 32 may change the number of buttons included in the operation screen, in accordance with the size of the first window (operation screen display area). For example, when the size of the operation screen including buttons with the size designated in the operation screen information 109A (button information) becomes larger than the operation screen display area, the number of buttons included in the operation screen may be decreased in accordance with the size of the operation screen area. Specifically, the operation screen generation module 32 selects, from among the buttons, a number of buttons which can be included within the size of the operation screen display area. The screen generation module 32 then generates an operation screen including the selected buttons. The buttons to be included in the operation screen are selected from the plurality of buttons, based on, for example, the “Priority” of “Button information”.

Next, referring to FIGS. 5 to 7, a description is given of examples of the operation screen which is displayed by the operation screen control program 202.

In the example shown in FIG. 5, it is assumed that the application program 203 is a Web browser. A window 41 of the Web browser includes, for example, a title bar 411, a “Back” button 412, a “Forward” button 413, a URL input area 414, an “Update” button 415, a “Stop” button 416, a search word input area 417, and a “Favorites” button 418.

In response to the user tapping (touching) the title bar 411 by, for example, a finger 42, the operation screen control program 202 displays an operation screen 45 on the window 41 in an overlapping manner. The operation screen 45 includes, for example, a “Back” button 452, a “Forward” button 453, a “URL” button 454, an “Update” button 455, a “Stop” button 456, a “Search” button 457, a “Favorites” button 458, a “Zoom” button 459, and a “Help” button 460.

The operation screen 45 is displayed, for example, such that the operation screen 45 is laid over an area (operation screen display area) excluding the title bar 411 in the window 41. Accordingly, the buttons 452 to 460 included in the operation screen 45 are set at sizes which are determined by dividing the operation screen display area in accordance with the number of buttons included in the operation screen 45, the arrangement of the buttons, etc.

The operation screen 45 includes, for example, buttons corresponding to functions which are frequently used in the Web browser. In addition, the operation screen 45 includes, for example, buttons which can instruct execution of functions which are similar to the functions of objects (GUI) included in the window 41 of the Web browser. For example, when the “Back” button 452 in the operation screen 45 has been touched, the Web browser (application program 203) is instructed to execute a function of going back to a Web page which was displayed immediately before, based on the history of browsing of Web pages, as in the case where the “Back” button 412 in the window 41 of the Web browser has been touched. In addition, for example, when the “URL” button 454 has been touched, the Web browser is instructed to execute a function of moving an input cursor to the URL input area 414 (i.e. a function of focusing on the URL input area 414), as in the case where the URL input area 414 has been touched.

Next, in the example shown in FIG. 6, it is assumed that the application program 203 is a media player for playing audio or video. A window 51 of the media player includes, for example, a title bar 511, a “Back” button 512, a “Forward” button 513, a search word input area 514, a “Replay” button 515, a “Play” button 516, a “Skip” button 517, a “Repeat” button 518, a “Stop” button 519, and a volume bar 520.

Responding to the user tapping (touching) the title bar 511 by, for example, a finger 52, the operation screen control program 202 displays an operation screen 55 on the window 51 in an overlapping manner. The operation screen 55 includes, for example, a “Back” button 552, a “Forward” button 553, a “Search word input” button 554, a “Replay” button 555, a “Play” button 556, a “Skip” button 557, a “Repeat” button 558, a “Stop” button 559, and a “Volume bar” button 560.

The operation screen 55 includes, for example, buttons corresponding to functions which are frequently used in the media player (software for playing audio or video). In addition, the operation screen 55 includes, for example, buttons which can instruct execution of functions which are similar to the functions of objects included in the window 51 of the media player. For example, when the “Play” button 556 included in the operation screen 55 has been touched, the media player (application program 203) is instructed to execute a function of playing audio or video, as in the case where the “Play” button 516 included in the window 51 of the media player has been touched. In addition, for example, when the “Volume bar” button 560 has been touched, the media player is instructed to execute a function of controlling a sound volume in accordance with the movement of a dial indicative of a volume on the “Volume bar” button 560, as in the case where a dial of the volume bar 520 has been moved.

The example of FIG. 7 shows an operation screen 65 which is displayed when the application program 203 corresponding to the first window on which the input has been detected (i.e. the application program 203 which is being operated) cannot be specified, or when there is no entry of the operation screen information 109A associated with the application program 203 which is being operated.

In response to the user tapping (touching) a title bar 611 by, for example, a finger, the operation screen control program 202 displays an operation screen 65 on a window 61 in an overlapping manner. The operation screen 65 includes, for example, a “Minimize” button 652, a “Maximize” button 653, a “Close” button 654, a “Left resize” button 655, a “Move” button 656, an “Right resize” button 657, a “Left and bottom resize” button 658, a “Bottom resize” button 659, and an “Right and bottom resize” button 660.

The operation screen 65 includes buttons corresponding to functions which are commonly used in various application programs. For example, when the “Minimize” button 652 included in the operation screen 65 has been touched, the application program 203 is instructed to execute a function of minimizing the window 61. When the “Move” button 656 has been touched, the application program 203 is instructed to execute a function of moving the window 61. When the “Bottom resize” button 659 has been touched, the application program 203 is instructed to execute a function of resizing the window 61 in a downward direction.

As has been described above, responding to the title bar in the window being touched, the operation screen control program 202 can display different operation screens in accordance with the application program 203 corresponding to the window. The displayed operation screen includes buttons for instructing, for example, a function which is necessary according to the application program 203, a function which is unique to the application program 203, and a function which is frequently used in the application program 203. Thereby, the operation screen control program 202 can display an operation screen which is suited to the application program 203 that is being operated. Using the displayed operation screen, the user touches a button corresponding to the function that is to be used. Thereby, the operability of the application program 203 is improved.

In the meantime, the operation screen, which varies in accordance with the application program, as shown in FIG. 5 and FIG. 6, and the operation screen, which is common to various application programs, as shown in FIG. 7, may selectively be displayed in accordance with a position in the title bar which has been tapped by the user. For example, when the user has tapped a left-side area in the title bar, the operation screen control program 202 (operation screen display control module 33) displays the operation screen which is common to various application programs. On the other hand, when the user has tapped a right-side area in the title bar, the operation screen control program 202 (operation screen display control module 33) displays the operation screen which varies in accordance with the application program.

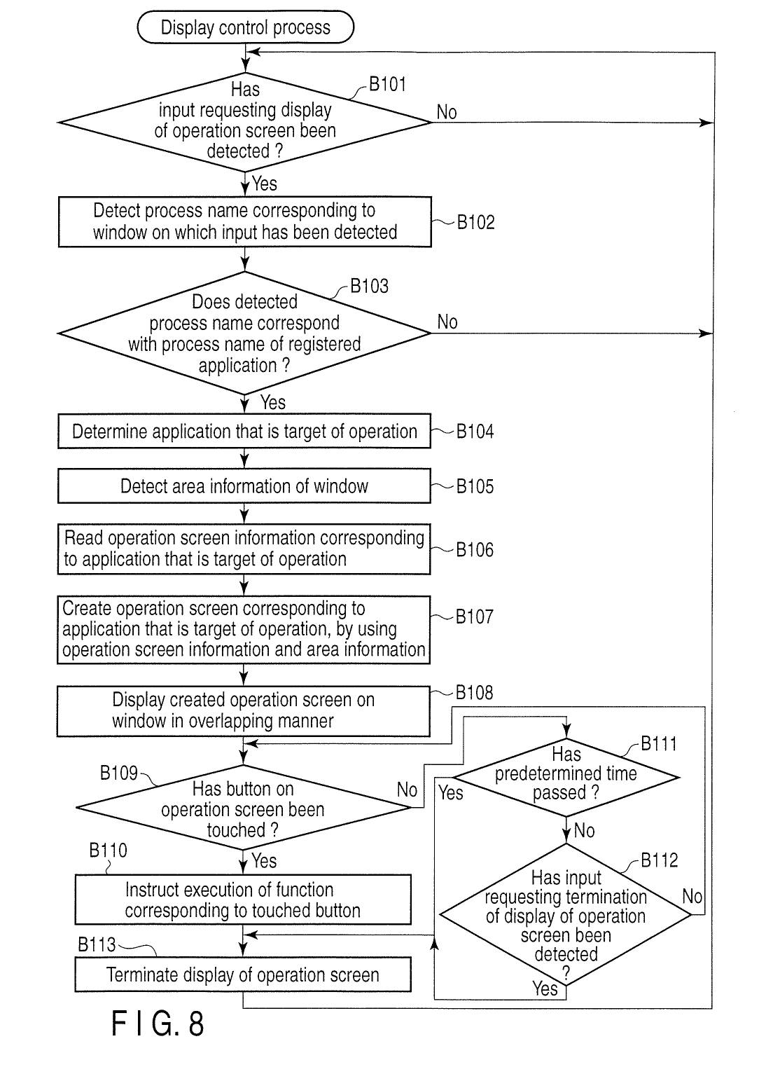

Next, referring to a flowchart of FIG. 8, a description is given of an example of the procedure of a display control process executed by the electronic apparatus 10.

To start with, the input detection module 31 determines whether an input requesting the display of an operation screen has been detected (block B101). The input detection module 31 detects, for example, the touch on the title bar in the window, as the input requesting the display of an operation screen. When the input requesting the display of an operation screen has not been detected (NO in block B101), the input detection module 31 determines whether an input requesting the display of an operation screen has been detected by returning to the process of block B101.

When the input requesting the display of an operation screen has been detected (YES in block B101), the operation screen generation module 32 detects a process name corresponding to the window (the window that is the target of operation) on which the input has been detected (block B102).

Subsequently, the operation screen generation module 32 determines whether the detected process name agrees with the process name of a registered application program (block B103). The operation screen generation module 32 executes the determination, for example, by comparing the detected process name and a process name which is pre-registered in the registry.

When the detected process name agrees with the process name of the registered application program (YES in block B103), the operation screen generation module 32 determines the application program 203 that is the target of operation (block B104). Specifically, the operation screen generation module 32 determines the application program 203 corresponding to the window on which the input has been detected, among a plurality of application programs.

Then, the operation screen generation module 32 detects area information corresponding to the targeted window (block B105). The area information includes, for example, information indicative of the size of the window, the position of the window, etc. Subsequently, the operation screen generation module 32 reads the operation screen information 109A corresponding to the targeted application program 203 from the HDD 109 (block B106). Using the read operation screen information 109A and the detected area information, the operation screen generation module 32 creates an operation screen corresponding to the targeted application program 203 (block B107). This operation screen includes buttons for operating the targeted application program 203. The operation screen generation module 32 outputs the created operation screen to the operation screen display control module 33. The operation screen display control module 33 displays the operation screen on the window displayed on the touch-screen display 17 in an overlapping manner (block B108). The operation screen display control module 33 displays the operation screen, for example, in a semi-transparent manner.

Then, the input detection module 31 determines whether one of the buttons in the displayed operation screen has been touched (block B109). When the button has been touched (YES in block B109), the execution control module 34 instructs the targeted application program 203 to execute the function corresponding to the touched button (block B110).

When the button has not been touched (NO in block B109), the operation screen display control module 33 determines whether an elapsed time period after the display of the operation screen, during which none of the buttons in the operation screen is touched, has reached a threshold period (block B111). When the time period has not reached the threshold period (NO in block B111), the input detection module 31 determines whether an input requesting the termination of the display of the operation screen has been detected (block B112). The input detection module 31 detects, for example, the touch on the title bar in the window, as the input requesting the termination of the display of the operation screen. When the input requesting the termination of the display of the operation screen has not been detected (NO in block B112), the process returns to block B109.

The operation screen display control module 33 terminates the display of the operation screen, when the time period has reached the threshold period (YES in block B111), or when the input requesting the termination of the display of the operation screen has been detected (YES in block B112), or after the execution of the function corresponding to the touched button has been instructed in block B110 (block B113).

By the above-described process, the user can easily execute an input by using the touch-screen display 17. When a predetermined area in the window has been touched, the operation screen generation module 32 displays the operation screen including buttons for operating the application program 203, based on the operation screen information associated with the application program 203 corresponding to the window. By touching the button included in the operation screen, the user can instruct the application program 203 to execute the function corresponding to the touched button, more easily than touching the object included in the window. In the meantime, the operation screen information 109A for generating the operation screen may be changed by the user. In addition, the operation screen information 109A for generating the operation screen may be changed so that buttons corresponding to those of the functions executed by the application program 203, which are frequently used by the user, may be displayed.

As has been described above, according to the present embodiment, an input can easily be executed by using the touch-screen display 17. When a predetermined area in the first window of a plurality of windows has been touched, the operation screen control program 202 detects the first application program 203 corresponding to the first window among a plurality of application programs. The operation screen control program 202 displays the operation screen including buttons for operating the first application program on the touch-screen display based on a first operation screen information item of a plurality of operation screen information items, which is associated with the detected first application program 203. The displayed operation screen includes buttons for instructing, for example, a function which is necessary according to the application program 203, a function which is unique to the application program 203, and a function which is frequently used in the application program 203. By touching a button corresponding to a function which is to be used, with use of the displayed operation screen, the user can easily execute an input to instruct the execution of the function.

In the above description, the input using the touch-screen display 17 has been described. However, also in the case of executing an input using the pointing device 16, the input can easily be executed with use of the operation screen.

All the procedures of the display control process of the present embodiment may be executed by software. Thus, the same advantageous effects as with the present embodiment can easily be obtained simply by installing a program, which executes the procedures of the display control process, into an ordinary computer through a computer-readable storage medium which stores the program, and executing this program.

While certain embodiments of the invention have been described, these embodiments have been presented by way of example only, and are not intended to limit the scope of the invention. These novel embodiments may be implemented in a variety of other forms; furthermore, various omissions, substitutions and changes may be made without departing from the spirit of the invention. The embodiments and their modifications are included in the scope and spirit of the inventions, and fall within the scope of the claimed inventions and their equivalents.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to display one or more windows of a plurality of windows on a touch-screen display, the plurality of windows corresponding to a plurality of application programs, the electronic apparatus comprising:
a storage device configured to store a plurality of operation screen information items associated with the plurality of application programs;
a display control module configured to display a operation screen on the touch-screen display based on a first operation screen information item of the plurality of operation screen information items when a predetermined area in a first window of the plurality of windows has been touched, the operation screen comprising a plurality of buttons for operating a first application program of the plurality of application programs, the first operation screen information item being associated with the first application program, the first application program corresponding to the first window; and
an execution control module configured to instruct the first application program to execute a function corresponding to a button of the plurality of buttons on the operation screen in response to the button being touched.

2. The electronic apparatus of claim 1, wherein the plurality of buttons in the operation screen are respectively larger than buttons for operating the first application program in the first window.

3. The electronic apparatus of claim 1, wherein the plurality of buttons in the operation screen comprises a first button which is larger than a second button for operating the first application program in the first window.

4. The electronic apparatus of claim 1, wherein the display control module is configured to change a size of the first window in accordance with a size of the operation screen, and to display the operation screen on the first window, the size of which has been changed, in an overlapping manner.

5. The electronic apparatus of claim 4, wherein the display control module is configured to transparently display the operation screen on the first window, the size of which has been changed.

6. The electronic apparatus of claim 5, wherein the display control module is configured to display the operation screen with a transparency associated with the first application program.

7. The electronic apparatus of claim 1, wherein the display control module is configured to change a number of buttons in the operation screen in accordance with a size of the first window, and to display the operation screen on the first window in an overlapping manner, the operation screen comprising the changed number of buttons.

8. The electronic apparatus of claim 1, wherein the display control module is configured to change a size of the operation screen in accordance with a size of the first window, and to display the operation screen, the size of which has been changed, on the first window in an overlapping manner.

9. The electronic apparatus of claim 1, wherein the display control module is configured to terminate the display of the operation screen in response to the predetermined area of the first window being touched while the operation screen is displayed.

10. The electronic apparatus of claim 1, wherein the display control module is configured to terminate the display of the operation screen when an elapsed period has reached a threshold period, the elapsed period being a period during which none of the plurality of buttons in the operation screen is touched.

11. The electronic apparatus of claim 10, wherein the display control module is configured to terminate the display of the operation screen when an elapsed period has reached a threshold period associated with the first application program, the elapsed period being a period during which none of the buttons in the operation screen is touched.

12. The electronic apparatus of claim 1, wherein the display control module is configured to display a predetermined operation screen in response to a touch on a predetermined area in a window corresponding to an application program other than the plurality of application programs.

13. A display control method of controlling an electronic apparatus configured to display one or more windows of a plurality of windows on a touch-screen display, the plurality of windows corresponding to a plurality of application programs, the electronic apparatus comprising a storage device configured to store a plurality of operation screen information items associated with the plurality of application programs, the method comprising:
displaying an operation screen on the touch-screen display based on a first operation screen information item of the plurality of operation screen information items when a predetermined area in a first window of the plurality of windows has been touched, the operation screen comprising a plurality of buttons for operating a first application program of the plurality of application programs, the first operation screen information item being associated with the first application program, the first application program corresponding to the first window; and
instructing the first application program to execute a function corresponding to a button of the plurality of buttons on the operation screen in response to the button being touched.

14. A non-transitory computer readable medium having stored thereon a program for controlling a computer configured to display one or more windows of a plurality of windows on a touch-screen display, the computer comprising a storage device configured to store a plurality of operation screen information items associated with a plurality of application programs, the plurality of windows corresponding to the plurality of application programs, the program being configured to cause the computer to:
display an operation screen on the touch-screen display based on a first operation screen information item of the plurality of operation screen information items when a predetermined area in a first window of the plurality of windows has been touched, the operation screen comprising a plurality of buttons for operating a first application program of the plurality of application programs, the first operation screen information item being associated with the first application program, the first application program corresponding to the first window; and
instruct the first application program to execute a function corresponding to a button of the plurality of buttons on the operation screen in response to the button being touched.
